(19) United States
(12) Patent Application Publication
(10) Pub. No.: US 2003/0072053 A1
(43) Pub. Date: Apr. 17, 2003

(54) Closed-loop optical network system and an associated transceiver and method for transmitting a plurality of optical signals

(75) Inventors: Thomas L. Weaver, Webster Groves, MO (US); Ronald H. Smith, Rockville, MD (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company, Seattle, WA

(21) Appl. No.: 09/975,168

(22) Filed: Oct. 11, 2001

(51) Int. Cl. H04J 14/02; H04B 10/00

(52) U.S. Cl. 359/124; 359/152

(57) ABSTRACT

A closed-loop optical network system includes a multi-mode network bus for transmitting a plurality of optical signals. The system further includes a multiplexer, a plurality of remote devices and a demultiplexer. The multiplexer can wavelength division multiplex a plurality of input optical signals for transmission via the network bus, where the input optical signals have a plurality of predetermined optical wavelengths. The remote devices are optically connected to the network bus, and can read optical signals having respective predefined optical wavelengths off of the network bus. Further, the remote devices can write optical signals having respective predefined optical wavelengths onto the network bus. The demultiplexer is capable of receiving optical signals having at least one of the plurality of predetermined optical wavelengths from the network bus and thereafter wavelength division demultiplexing the optical signals into a plurality of output optical signals.

### FEDERALLY SPONSORED RESEARCH OR DEVELOPMENT

This invention was made with government support under Contract No. F33615-98-C-3611 awarded by the United States Air Force. The government may have certain rights in this invention.

### FIELD OF THE INVENTION

The present invention relates to control systems and methods of transmitting optical signals and, more particularly, to closed-loop optical network systems and methods of transmitting optical signals over a multi-mode network bus.

### BACKGROUND OF THE INVENTION

In various complex systems today, such as factories, public utilities, and vehicles, any one of a number of approaches to integration and control systems are used, including mechanical, pneumatic, hydraulic, electric, and photonic systems. The most complex systems employ electric and photonic systems. For example, vehicles typically include electric systems, while factories and offices often employ electric and/or photonic systems. And data processing systems and communication systems often utilize photonic systems.

Electric systems for vehicle management are serviceable, but tend to be heavy and difficult to maintain due to large amounts of active electronics required at each network node. Electric networks are also susceptible to interference from electromagnetic radiation. As a result, shielding and signal encoding are typically implemented to provide resistance to the electromagnetic interference. But adding the shielding and signal encoding undesirably add to the weight and complexity of the system. Whereas weight is not generally an issue for electric networks for factories and offices, adding the signal encoding does present factories and offices with problems relating to complexity and electromagnetic interference, similar to that suffered by vehicle networks.

In light of the problems suffered by electric networks, photonic networks implemented with single mode optical technologies provide much greater bandwidth capability. Further, if implemented with single mode wavelength division multiplexing (WDM) optical technologies, these photonic networks perform required functions with simple architectures, compared to the complex architectures of electric networks. However, present photonic networks also suffer from problems. They are normally single mode systems, which are expensive to implement, difficult to install and maintain, and only tolerate environments more benign than most aerospace and many factory environments. Additionally, the common approach of physically configuring photonic networks in tree or mesh layouts generally requires active electronics at each node in the network. That, in turn, drives up costs, which limits current generation photonic systems to those systems where very large amounts of data are transmitted among a small number of ports separated by large distances. Further, the environmental characteristics limit applications to those in which all components are in benign environments.

### SUMMARY OF THE INVENTION

In light of the foregoing background, the present invention provides a closed-loop optical network system utilizing wavelength division multiplexing of signals in a multi-mode fiber optic infrastructure. The present invention supports a large number of accessible remote devices in an inexpensive and highly robust system, as compared to conventional systems. As compared to electric networks, the present invention employs fiber optic technology to achieve high bandwidth, light weight, electromagnetic interference resistant operation. And as compared to conventional photonic networks, the present invention employs a closed-loop, multi-mode wavelength division multiplexing (WDM) technology to provide inexpensive and environmentally robust operation.

According to one embodiment, a closed-loop optical network system includes a multi-mode network bus for transmitting a plurality of optical signals. The system further includes a multiplexer, a plurality of remote devices and a demultiplexer. The multiplexer is capable of wavelength division multiplexing the plurality of input optical signals for transmission via the network bus. In this regard, the input optical signals have a plurality of predetermined optical wavelengths. The system may further include a plurality of optical sources capable of generating the plurality of input optical signals from a plurality of input electrical signals. The system may also include a network controller for controlling communications on the network bus, where the network controller is capable of transmitting the plurality of input electrical signals to the optical sources.

The remote devices are optically connected to the network bus and are capable of reading optical signals having respective predefined optical wavelengths off of the network bus. The remote devices are further capable of writing optical signals having respective predefined optical wavelengths onto the network bus. The respective predefined optical wavelengths of the signals read and written by the remote devices are at least subsets of the plurality of predetermined optical wavelengths of the optical input signals.

The demultiplexer can receive optical signals having at least one of the plurality of predetermined optical wavelengths from the network bus and thereafter wavelength division demultiplex the optical signals into a plurality of output optical signals. The system may further include a plurality of optical detectors capable of receiving the plurality of output optical signals from the demultiplexer and thereafter generating a plurality of output electrical signals from the plurality of output optical signals. The optical detectors are capable of transmitting the plurality of output optical signals to the network controller.

In operation, the input optical signals are transmitted via the network bus which, in turn, includes wavelength division multiplexing the plurality of input optical signals having respective predetermined optical wavelengths for transmission via the network bus. In one embodiment, the input optical signals are generated from a plurality of input electrical signals before transmitting the input optical signals. The input electrical signals may be produced before the input optical signals are generated.

Communication is then established with remote devices optically connected to the network bus, with the remote device reading optical signals having respective predefined optical wavelengths off of the network bus. In one embodiment, the remote devices may also write optical signals having respective predefined optical wavelengths onto the network bus.

Next, optical signals having at least one of the plurality of predetermined optical wavelengths are received from the network bus and thereafter wavelength division demultiplexed into a plurality of output optical signals. In an advantageous embodiment, the optical signals are received after transmission about a closed loop on the network bus from a transmitter to a receiver. After wavelength division demultiplexing the optical signals, a plurality of output electrical signals may be generated from the plurality of output optical signals. The output optical signals are then typically transmitted to a network controller.

The present invention also provides a transceiver for transmitting input optical signals to and receiving output optical signals from a plurality of remote devices via a multi-mode network bus in a closed-loop optical network system. The transceiver includes a plurality of optical sources, a multiplexer and a demultiplexer. The optical sources are capable of generating the plurality of input optical signals from a plurality of input electrical signals. In one embodiment, the optical sources are also capable of communicating with a network controller, which serves to transmit the plurality of input electrical signals to the optical sources.

The multiplexer can wavelength division multiplex the plurality of input optical signals for transmission via the network bus. The input optical signals have a plurality of predetermined optical wavelengths that are selectively received by respective remote devices. In this regard, the remote devices read and write optical signals having predefined optical wavelengths that are at least a subset of the plurality of predetermined optical wavelengths of the optical input signals.

The demultiplexer is capable of receiving optical signals having at least one of the plurality of predetermined optical wavelengths from the network bus and thereafter wavelength division demultiplexing the optical signals into a plurality of output optical signals. In one embodiment, the transceiver further includes a plurality of optical detectors capable of receiving the output optical signals from the demultiplexer and thereafter generating a plurality of output electrical signals from the output optical signals. And in a further embodiment, the optical detectors are capable of transmitting the plurality of output optical signals to a network controller.

One advantageous embodiment of the present invention additionally provides a vehicle adapted to support optical communications. The vehicle includes a vehicle body capable of including at least one closed-loop optical network system. And the vehicle includes a closed-looped optical network system including a multi-mode network bus, a multiplexer, a plurality of remote devices and a demultiplexer. The multi-mode network bus is disposed at least partially throughout the vehicle body for transmitting a plurality of optical signals.

The multiplexer of the closed-loop optical network system is capable of wavelength division multiplexing a plurality of input optical signals having a plurality of predetermined optical wavelengths for transmission via the network bus. And the remote devices, which are optically connected to the network bus and disposed at least partially throughout the vehicle body, are capable of reading optical signals having respective predefined optical wavelengths off of the network bus. The plurality of remote devices are further capable of writing optical signals having respective predefined optical wavelengths onto the network bus.

The closed-loop optical network system of the vehicle further includes the demultiplexer, which can receive optical signals having at least one of the plurality of predetermined optical wavelengths from the network bus and thereafter wavelength division demultiplexing the optical signals into a plurality of output optical signals.

The present invention therefore utilizes wavelength division multiplexed signals in a multi-mode fiber optic infrastructure to provide a closed-loop optical network system that supports a large number of accessible remote devices in an inexpensive and highly robust system, as compared to conventional systems. The present invention provides a fiber optic system to achieve high bandwidth, light weight, electromagnetic interference resistant operation, as compared to electric networks. The present invention further provides inexpensive and environmentally robust operation, as compared to conventional photonic networks.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a closed-loop optical network system, according to one embodiment of the present invention;

FIG. 2 is a flow chart illustrating various steps in a method of transmitting a plurality of optical signals over a multi-mode network bus in a closed-loop network system, according to one embodiment of the present invention; and

FIG. 3 is a schematic diagram of an aircraft including a closed-loop optical network system, according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

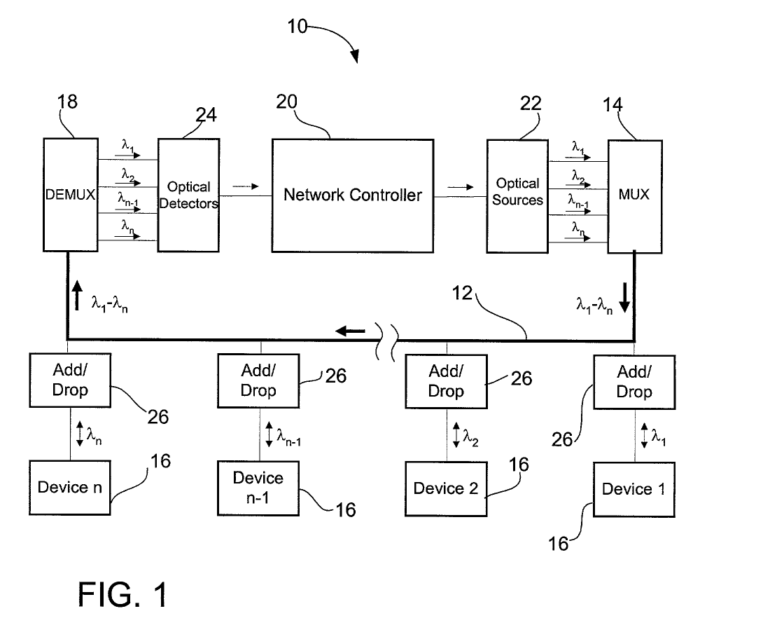

Referring to FIG. 1, a closed-loop optical network system 10 includes a network bus 12, a multiplexer 14, a plurality of remote devices 16 and a demultiplexer 18. The network system can also include a network controller 20 for controlling communications on the network bus. Further, the system can include a plurality of optical sources 22 and a plurality of optical detectors 24 capable of generating and receiving optical signals transmitted via the network bus, respectively.

As stated, conventional photonic networks, which transmit in single mode, are expensive to implement, difficult to install and maintain, and only tolerate environments more benign than most aerospace and many factory environments. In contrast, the network bus 12 of the present invention is a multi-mode network bus, such as a fiber optic cable having a plurality of multi-mode fiber optical fibers. As known to those skilled in the art, multi-mode fiber provides high bandwidth at high speeds over medium distances, typically less than two kilometers. Optical signals are dispersed into numerous paths, or modes, as the optical signals travel through the cable's core. The multi-mode network bus can have any of a number of dimensions, but multi-mode fiber optic cables typically include larger fiber core diameters of 50, 62.5, or 100 microns, as opposed to 8.3 to 10 microns in single mode fiber optic cables.

The network controller 20 can comprise any number of devices, such as a personal computer or other high level processor. Alternatively, the network controller can comprise a plurality of electronic components configured as an application specific integrated circuit (ASIC). The network controller is capable of generating a plurality of input electrical signals consisting of communication signals directed to one or more of the remote devices. The input electrical signals will vary depending upon the application of the closed-loop optical network system 10, but may include control signals or the like. As such, the network controller may be configured or otherwise programmed to provide appropriate electrical signals. Alternatively, the network controller may receive direction from other devices, such as the flight management system in applications in which the closed-loop optical network system is disposed onboard an aircraft.

The optical sources 22 generate a plurality of input optical signals from the input electrical signals. The input optical signals have a plurality of predetermined optical wavelengths, λ₁-λₙ. Although the closed-loop optical network system 10 may be configured such that multiple remote devices 16 receive signals having the same wavelength, the exemplary embodiment described below and illustrated in FIG. 1 is designed such that each predetermined optical wavelength is preferably associated with and received by one remote device (assuming a network with n remote devices). In this regard, the optical sources can comprise any of a number of devices that generate optical signals from electrical signals, where the optical signals can have different wavelengths, such as array of edge emitting lasers. In a preferred embodiment, however, the optical sources consist of an array of Vertical Cavity Surface Emitting Lasers (VCSEL) due to the environmental tolerance of VCSELs.

The multiplexer 14 receives the input optical signals and wavelength division multiplexes (WDM) the input optical signals for transmission via the network bus 12. As known, WDM is a multiplexing method whereby multiple optical signals, each given a color (a wavelength or specific frequency), are transmitted via the same optical fiber. The use of WDM allows the system to operate in a closed-loop configuration, as opposed to the more conventional complex tree configurations. In this regard, conventional complex tree configurations require active electronics at each remote device, but only use one optical wavelength in each of many point-to-point links between a network controller and respective remote devices.

The system 10 further includes a plurality of remote devices 16 connected to the network bus 12 at respective nodes. The number of data channels (e.g., frequencies) needed at a node depends on the bandwidth required by the respective remote device. Within each channel, any known optical encoding method can be implemented, such as Fibre Channel, Gigabit Ethernet or analog subcarrier multiplexing, independently of the encoding methods implemented on other channels. The remote devices can comprise any of a number of devices, such as sensors and actuators, which read data off of and/or write data onto the network bus. To communicate with specific ones of the remote devices, the remote devices are configured to selectively read optical signals having one or more predefined wavelengths from the network bus and/or to write optical signals having one or more predefined wavelengths onto the network bus. In this regard, each remote device is preferably includes or is otherwise associated with an add/drop multiplexer 26.

As known to those skilled in the art, add/drop multiplexers 26 serve as the entry/exit point for signals having different wavelengths in the composite optical signal. The add/drop multiplexers can selectively remove or insert signals having predefined wavelengths without having to regenerate all of the other individual input optical signals in the composite optical signal. The add/drop multiplexers can use fixed wavelength channel assignments if the nodes are intended to be passive such that each add/drop multiplexer always reads and/or writes optical signals having the same predefined wavelength(s). Alternatively, one or more add/drop multiplexers may use selectable wavelength assignments if desired, and if the environment allows active remote devices at the respective nodes, thereby permitting the wavelength(s) of the optical signals read and/or written by the add/drop multiplexers to be selectively controlled. The add/drop multiplexers are configured to read optical signals having the respective predefined optical wavelength(s) from the network bus and, in some embodiments, to write optical signals having the predefined optical wavelength(s) onto the network bus. As such, the network controller can communicate with particular remote devices via optical signals having the predefined optical wavelength(s) with which the respective remote devices communicate. For example, if two remote devices are associated with add/drop multiplexers configured to read and/or write optical signals having wavelengths of 1546 nm and 1550 nm optical wavelength signals, respectively, the network controller 20 in conjunction with the optical sources 22 can provide input optical signals having wavelengths of 1546 nm and 1550 nm.

The system 10 includes the demultiplexer 18 to receive optical signals having at least one of the plurality of predetermined optical wavelengths. As not every remote device need transmit optical signals back onto the network bus 12, the optical signals received by the demultiplexer need not include all of the predetermined optical wavelengths. The demultiplexer, consistent with the multiplexer 14, is capable of wavelength division demultiplexing the optical signals into a plurality of output optical signals having respective predetermined optical wavelengths. The output optical signals can comprise any of a number of different communication signals, but typically comprise feedback to the network controller 20. As such, the plurality of output optical signals are then received by a plurality of optical detectors 24, such as an array of photodiodes, which generate a plurality of output electrical signals from the output optical signals. The output electrical signals can then be transmitted to the network controller. Thus, communications can be selectively established via the common, multi-mode network bus between the network controller and a plurality of remote devices.

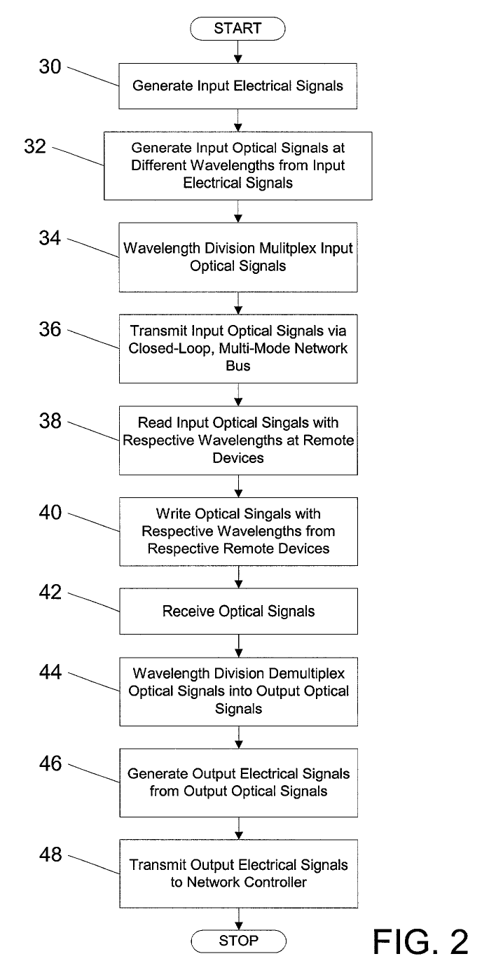

Referring now to FIG. 2, a method for transmitting a plurality of optical signals over a multi-mode network bus 12 in a closed-loop network system 10 generally begins by generating input electrical signals, such as at the network controller 20. (Block 30). Then, input optical signals are generated from the input electrical signals, such as from the plurality of optical sources 22. (Block 32). In this regard, the input optical signals have a plurality of predetermined optical wavelengths and comprise communications to a plurality of remote devices 16. Next, the input optical signals are wavelength division multiplexed for transmission via the multi-mode network bus. (Blocks 34 and 36).

As the input optical signals propagate along the network bus 12, remote devices 16 selectively read the input optical signals off of the network bus. In this regard, the remote devices read optical signals having respective predefined optical wavelengths. (Block 38). Additionally, or alternatively, if desired, the remote devices can write optical signals having respective predefined optical signals onto the network bus, such as via add/drop multiplexers 26. (Block 40). Optical signals having at least one of the predetermined optical wavelengths are then received, such as by the demultiplexer 18. (Block 42). And thereafter, the demultiplexer performs wavelength division demultiplexing to separate the optical signals into a plurality of output optical signals. (Block 44).

A plurality of output electrical signals are then generated from the output optical signals, such as by the optical detectors 24. (Block 46). The output electrical signals are then transmitted, such as to the network controller 20. (Block 48). As such, the network controller can receive signals from at least one of the remote devices 16.

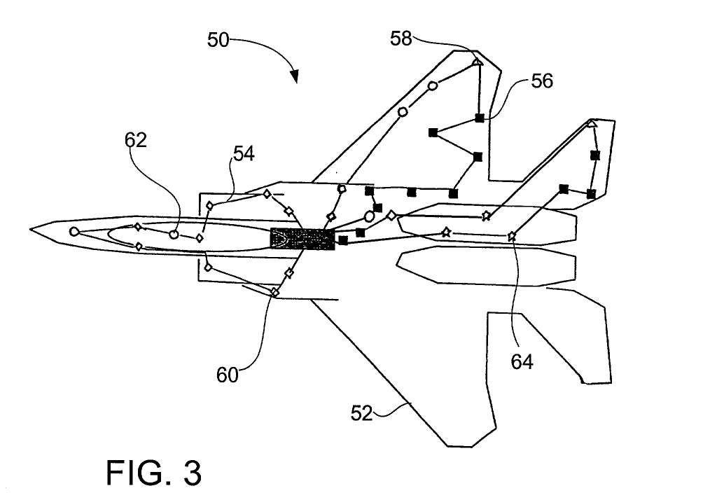

Referring now to FIG. 3, one advantageous embodiment of the present invention further provides a vehicle 50 adapted to support optical communications. The vehicle can comprise any of a number of different types of vehicles, such as an aircraft (shown), an automobile or the like. The vehicle includes a vehicle body 52 capable of including at least one closed-loop optical network system. In this regard, the closed-loop optical network system can include a multi-mode network bus 54, a multiplexer (not shown), a plurality of remote devices 56-64, and a demultiplexer (not shown), such as those described above. Although not illustrated, the closed-loop optical network system can additionally include a network controller, a plurality of optical sources and a plurality of optical detectors, such as those described above.

The multi-mode network bus 54 is disposed at least partially throughout the vehicle body 52 and transmits optical signals, preferably along the lines described above. In the illustrated embodiment, the closed-loop optical network system can be used onboard an aircraft to control and monitor actuators and sensors. For example, the aircraft can use the network to issue commands to devices such as actuators controlling flight surfaces and to receive feedback signals, such as position responses from those actuators. The aircraft can also use the network to monitor various critical structural locations for strains 56, such as wing root, wing surface, tail root, tail cord and landing gear strains, and accelerations 58, such as wing tip and tail tip accelerations. Additionally, the network can be used to monitor the pressure 60 at various critical structural locations, such as critical belly pressures for sonic fatigue, as well as key corrosion locations 62 for radar, landing gear and leading edges, and engine casing temperatures 64.

The present invention provides a closed-loop network system and an associated method and transceiver for transmitting a plurality of optical signals. The present invention wavelength division multiplexes the optical signals for transmission in a multi-mode fiber optic infrastructure to provide a closed-loop optical network system that supports a large number of accessible remote devices in an inexpensive and highly robust system, as compared to conventional systems. The present invention also provides a fiber optic system to achieve high bandwidth, light weight, electromagnetic interference resistant operation, as compared to electric networks. Further, the present invention provides inexpensive and environmentally robust operation, as compared to conventional photonic networks.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A closed-loop optical network system comprising:
a multi-mode network bus for transmitting a plurality of optical signals;
a multiplexer capable of wavelength division multiplexing a plurality of input optical signals for transmission via the network bus, wherein the plurality of input optical signals have a plurality of predetermined optical wavelengths;
a plurality of remote devices optically connected to the network bus, wherein said plurality of remote devices are capable of reading optical signals having respective predefined optical wavelengths off of the network bus, and wherein said plurality of remote devices are further capable of writing optical signals having respective predefined optical wavelengths onto the network bus; and
a demultiplexer capable of receiving optical signals having at least one of the plurality of predetermined optical wavelengths from the network bus and thereafter wavelength division demultiplexing the optical signals into a plurality of output optical signals.

2. A closed-loop optical network system according to claim 1 further comprising a plurality of optical sources capable of generating the plurality of input optical signals from a plurality of input electrical signals.

3. A closed-loop optical network system according to claim 2 further comprising a network controller for controlling communications on the network bus, wherein said network controller is capable of transmitting the plurality of input electrical signals to said plurality of optical sources.

4. A closed-loop optical network system according to claim 1 further comprising a plurality of optical detectors capable of receiving the plurality of output optical signals from said demultiplexer and thereafter generating a plurality of output electrical signals from the plurality of output optical signals.

5. A closed-loop optical network system according to claim 4, wherein said plurality of optical detectors are capable of transmitting the plurality of output electrical signals to a network controller.

6. A closed-loop optical network system according to claim 1, wherein said plurality of remote devices read and write optical signals having respective predefined optical wavelengths that are at least subsets of the plurality of predetermined optical wavelengths of the optical input signals.

7. A transceiver for transmitting input optical signals to and receiving output optical signals from a plurality of remote devices via a multi-mode network bus in a closed-loop optical network system, said transceiver comprising:
a plurality of optical sources capable of generating the plurality of input optical signals from a plurality of input electrical signals;
a multiplexer capable of wavelength division multiplexing a plurality of input optical signals for transmission via the network bus, wherein the plurality of input optical signals have a plurality of predetermined optical wavelengths that are selectively received by respective remote devices; and
a demultiplexer capable of receiving optical signals having at least one of the plurality of predetermined optical wavelengths from the network bus and thereafter wavelength division demultiplexing the optical signals into a plurality of output optical signals.

8. A transceiver according to claim 7, wherein said plurality of optical sources are capable of communicating with a network controller, wherein the network controller is capable of transmitting the plurality of input electrical signals to said plurality of optical sources.

9. A transceiver according to claim 7 further comprising a plurality of optical detectors capable of receiving the plurality of output optical signals from said demultiplexer and thereafter generating a plurality of output electrical signals from the plurality of output optical signals.

10. A transceiver according to claim 9, wherein the plurality of optical detectors of said receiving element are capable of transmitting the plurality of output electrical signals to a network controller.

11. A transceiver according to claim 7, wherein plurality of remote devices read and write optical signals having predefined optical wavelengths that are associated with the plurality of predetermined optical wavelengths of the optical input signals.

12. A method of transmitting a plurality of optical signals over a multimode network bus in a closed-loop network system, said method comprising the steps of:
transmitting a plurality of input optical signals via the network bus, wherein transmitting comprises wavelength division multiplexing the plurality of input optical signals for transmission via the network bus such that the plurality of input optical signals have a plurality of predetermined optical wavelengths;
communicating with a plurality of remote devices optically connected to the network bus, wherein said communicating comprises reading optical signals having respective predefined optical wavelengths off of the network bus; and
receiving optical signals having at least one of the plurality of predetermined optical wavelengths from the network bus and thereafter wavelength division demultiplexing the optical signals into a plurality of output optical signals.

13. A method according to claim 12, wherein communicating further comprises writing optical signals having respective predefined optical wavelengths onto the network bus.

14. A method according to claim 13, wherein writing optical signals comprises writing optical signals having respective predefined optical wavelengths that are at least a subset of the plurality of predetermined optical wavelengths of the optical input signals.

15. A method according to claim 12 further comprising generating the plurality of input optical signals from a plurality of input electrical signals, wherein said generating occurs before transmitting the plurality of input optical signals.

16. A method according to claim 15 further comprising producing the plurality of input electrical signals before generating the plurality of input optical signals.

17. A method according to claim 12, wherein receiving further comprises generating a plurality of output electrical signals from the plurality of output optical signals after wavelength division demultiplexing the composite optical signal.

18. A method according to claim 17, wherein generating the plurality of output electrical signals further comprises transmitting the plurality of output optical signals to a network controller after generating the output electrical signals.

19. A method according to claim 12, wherein communicating comprises reading optical signals having a plurality of predefined optical wavelengths that are at least a subset of the plurality of predetermined optical wavelengths of the optical input signals.

20. A method according to claim 12, wherein receiving the optical signals comprises receiving the optical signals after transmission about a closed loop on the network bus from a transmitter to a receiver.

21. A vehicle adapted to support optical communications comprising:
a vehicle body; and
a closed-looped optical network system comprising:
a multi-mode network bus disposed at least partially throughout said vehicle body for transmitting a plurality of optical signals;
a multiplexer capable of wavelength division multiplexing a plurality of input optical signals for transmission via the network bus, wherein the plurality of input optical signals have a plurality of predetermined optical wavelengths;
a plurality of remote devices optically connected to the network bus and disposed at least partially throughout said vehicle body, wherein said plurality of remote devices are capable of reading optical signals having respective predefined optical wavelengths off of the network bus, and wherein said plurality of remote devices are further capable of writing optical signals having respective predefined optical wavelengths onto the network bus; and
a demultiplexer capable of receiving optical signals having at least one of the plurality of predetermined optical wavelengths from the network bus and thereafter wavelength division demultiplexing the optical signals into a plurality of output optical signals.

22. A vehicle according to claim 21, wherein said closed-loop optical network system further comprises a plurality of optical sources capable of generating the plurality of input optical signals from a plurality of input electrical signals.

23. A vehicle according to claim 22, wherein said closed-loop optical network system further comprises a network controller for at least partially controlling communications on the network bus within said vehicle body, wherein said network controller is capable of transmitting the plurality of input electrical signals to said plurality of optical sources.

24. A vehicle according to claim 21, wherein said closed-loop optical network system further comprises a plurality of optical detectors capable of receiving the plurality of output optical signals from said demultiplexer and thereafter generating a plurality of output electrical signals from the plurality of output optical signals.

25. A vehicle according to claim 24, wherein the plurality of optical detectors of said closed-loop optical network system are capable of transmitting the plurality of output electrical signals to a network controller.

26. A vehicle according to claim 21, wherein the plurality of remote devices of said closed-loop optical network system read and write optical signals having respective predefined optical wavelengths that are at least subsets of the plurality of predetermined optical wavelengths of the optical input signals.
